(19) United States
(12) Patent Application Publication
(10) Pub. No.: US 2011/0307619 A1
(43) Pub. Date: Dec. 15, 2011

(54) RELAY PROCESSING METHOD AND RELAY APPARATUS

(75) Inventors: Takao OGURA, Kawasaki (JP); Masaaki Takase, Kawasaki (JP); Hitoshi Ueno, Kawasaki (JP)

(73) Assignee: FUJITSU LIMITED, Kawasaki-shi (JP)

(21) Appl. No.: 13/150,557

(22) Filed: Jun. 1, 2011

(30) Foreign Application Priority Data
Jun. 9, 2010 (JP) 2010-132273

(51) Int. Cl. G06F 15/16

(52) U.S. Cl. 709/228

(57) ABSTRACT

A relay apparatus is connected to a plurality of servers and a client to relay a message transmitted from the client to one of the plurality of servers. The relay apparatus receives from one of the plurality of servers a response to a first message transmitted from the client. The relay apparatus stores in a data storage a first server identifier of the server that has transmitted the response, in association with a first session identifier included in the response. The relay apparatus extracts, upon receiving a second message transmitted from the client, a second server identifier from the data storage on the basis of a second session identifier included in the second message. The relay apparatus determines a destination server of the second message on the basis of the extracted second server identifier. The relay apparatus transmits the second message destined to an address of the determined destination server.

### CROSS-REFERENCE TO RELATED APPLICATION

This application is based upon and claims the benefit of priority of the prior Japanese Patent Application No. 2010-132273, filed on Jun. 9, 2010, the entire contents of which are incorporated herein by reference.

### FIELD

The embodiments discussed herein are related to a relay apparatus to which a plurality of groups of servers which share and execute a plurality of application programs are connected.

### BACKGROUND

Presently, companies may use a plurality of servers to carry out operations. FIG. 1 illustrates an exemplary system including a plurality of servers. As illustrated in FIG. 1, a server rack 1000 accommodates a plurality of servers, and a group of server racks is handled as an “area” or “island” which is then connected to a lower network apparatus 120. The lower network apparatus 120 is connected via a higher network apparatus 130 to a network apparatus 140 included in a network 150, such as the Internet, outside of a base 110. As illustrated in FIG. 1, a plurality of bases 110 have one or more areas/islands and are connected via a network apparatus 140 included in a network 150, such as the Internet, outside of the base 110. This type of system configuration may be constructed by a company independently or may be constructed by a data center to provide services.

Such a server group has a plurality of programs (hereinafter, referred to as applications) describing work processes. When performing application cooperation, i.e., performing work processes described in a plurality of applications in cooperation, for example, when a work process described in an application APP_A and a work process described in an application APP_B are performed in cooperation, a user may access from a terminal a server SVR_1 performing the work process described in APP_A and then accesses from the terminal a server SVR_2 performing the work process described in APP_B. Since data generated in accessing SVR_1 performing the work process described in APP_A is used in the work process described in APP_B, SVR_2 performing the work process described in APP_B accesses SVR_1 to acquire necessary data. SVR_2 then performs the work process described in APP_B and returns a response to the terminal. In this way, communication between servers performing the work process described in APP_A and the work process described in APP_B is performed. Thus, it is preferable to perform the communication fast in order to return the response as quick as possible.

FIG. 2 illustrates an example of load distribution. As illustrated in FIG. 2, when an identical application exists in a plurality of servers, a load distribution apparatus (referred to as a load balancer) performs load distribution. The load balancer, for example, allots communication messages received from terminals to each of the plurality of servers sequentially by a method such as a round robin. Specifically, since APP_A is provided in servers SVR_1 to SVR_m, the load balancer transfers a communication message requesting to execute APP_A received from a terminal to one of the servers SVR_1 to SVR_m. Since APP_B is provided in servers SVR_n to SVR_x, the load balancer transfers a communication message requesting to execute APP_B received from a terminal to one of SVR_n to SVR_x.

When a plurality of servers having an identical configuration are connected to a relay apparatus and communication is performed plural times in one session between a terminal and one of the plurality of servers, the session identifier (ID) may be used as a key to transfer messages to the one of the plurality of servers according to some technology.

Japanese Laid-open Patent Publication No. 2002-163241 discloses a related technique.

### SUMMARY

According to an aspect of the present invention, provided is a relay processing method executed by a relay apparatus connected to a plurality of servers and a client to relay a message transmitted from the client to one of the plurality of servers. The relay apparatus receives from one of the plurality of servers a response to a first message transmitted from the client. The relay apparatus stores in a data storage a first server identifier in association with a first session identifier included in the response. The first server identifier is for identifying the one of the plurality of servers that has transmitted the response. The relay apparatus extracts, upon receiving a second message transmitted from the client, a second server identifier from the data storage on the basis of a second session identifier included in the second message. The second server identifier is for identifying an advance server. The relay apparatus determines a destination server of the second message on the basis of the extracted second server identifier. The destination server is one of the plurality of servers. The relay apparatus transmits the second message destined to an address of the determined destination server.

The object and advantages of the invention will be realized and attained by means of the elements and combinations particularly pointed out in the claims. It is to be understood that both the foregoing general discussion and the following detailed discussion are exemplary and explanatory and are not restrictive of the invention, as claimed.

### BRIEF DESCRIPTION OF DRAWINGS

FIG. 1 is a diagram illustrating an exemplary system including a plurality of servers;

FIG. 2 is a diagram illustrating an example of load distribution;

FIG. 3 is a diagram illustrating an example of application cooperation;

FIG. 4 is a diagram illustrating an example of application cooperation according to an embodiment of the present invention;

FIG. 5 is a diagram illustrating an exemplary functional configuration of a relay apparatus according to an embodiment of the present invention;

FIG. 6 is a diagram illustrating an exemplary time sequence of a system according to an embodiment of the present invention;

FIG. 7 is a diagram illustrating an example of an application execution data table according to an embodiment of the present invention;

FIG. 8 is a diagram illustrating an example of an application name acquisition table according to an embodiment of the present invention;

FIG. 9 is a diagram illustrating an example of a server group table according to an embodiment of the present invention;

FIG. 10 is a diagram illustrating an exemplary operation flow of a relay apparatus according to an embodiment of the present invention;

FIG. 11 is a diagram illustrating an example of a transfer rule table according to an embodiment of the present invention;

FIG. 12 is a diagram illustrating an example of a merged table according to an embodiment of the present invention;

FIG. 13 is a diagram illustrating an example of a merged table according to an embodiment of the present invention;

FIG. 14 is a diagram illustrating an example of application cooperation according to an embodiment of the present invention;

FIG. 15 is a diagram illustrating an example of an application name acquisition table according to an embodiment of the present invention;

FIG. 16 is a diagram illustrating an example of a server group table according to an embodiment of the present invention;

FIG. 17 is a diagram illustrating an example of an application execution data table according to an embodiment of the present invention;

FIG. 18 is a diagram illustrating an example of an application group table according to an embodiment of the present invention;

FIG. 19 is a diagram illustrating an exemplary operation flow of a relay apparatus according to an embodiment of the present invention;

FIG. 20 is a diagram illustrating an example of a transfer rule table according to an embodiment of the present invention;

FIG. 21 is a diagram illustrating an example of a merged table according to an embodiment of the present invention; and

FIG. 22 is a diagram illustrating an exemplary configuration of a computer.

### DESCRIPTION OF EMBODIMENTS

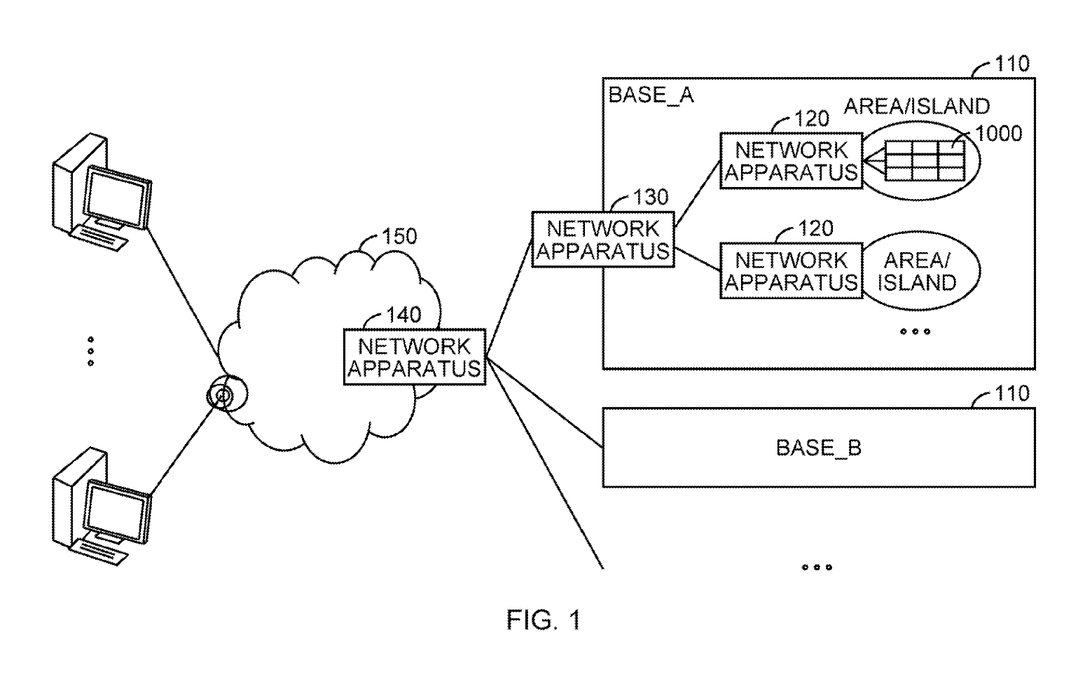

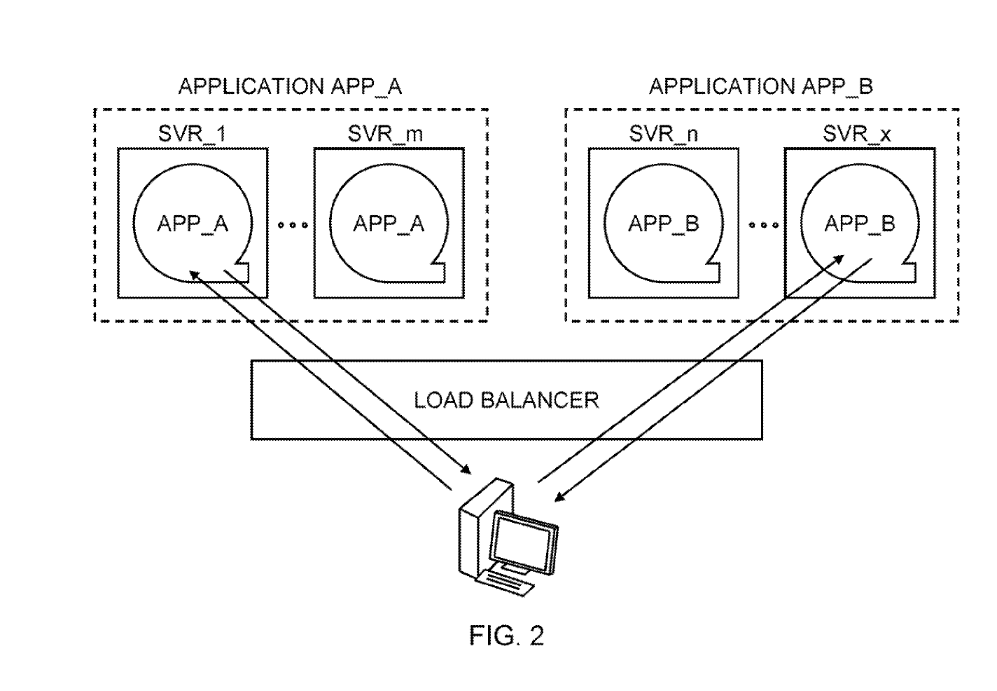

When work processes described in applications are not executed in cooperation, such a simple transfer rule mentioned above does not especially cause problems. However, a problem may occur when a plurality of applications are distributed over a plurality of areas/islands or a plurality of bases and work processes described in the plurality of applications are performed in cooperation in a system configuration as illustrated in FIG. 1.

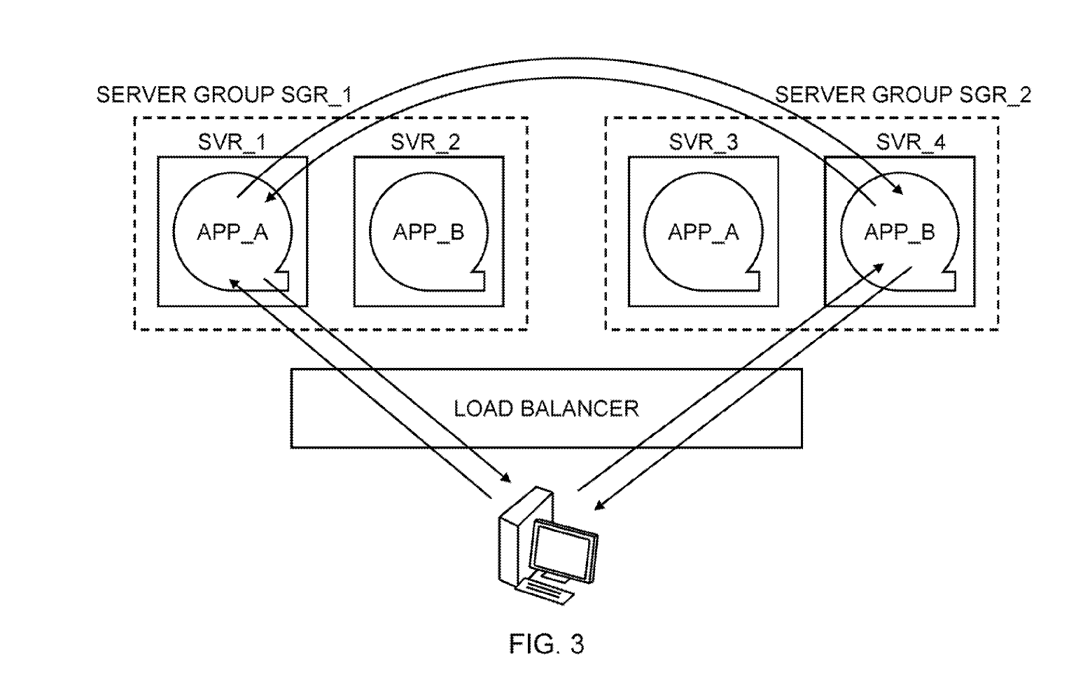

FIG. 3 illustrates an example of application cooperation. In FIG. 3, it is assumed that a server group SGR_1 corresponds to one rack, area/island or base, and a server group SGR_2 corresponds to another rack, area/island or base. Servers SVR_1 and SVR_2 included in SGR_1 have APP_A and APP_B, respectively. Servers SVR_3 and SVR_4 included in SGR_2 have APP_A and APP_B, respectively. A conventional load balancer may first select SVR_1 executing APP_A in SGR_1 and then select SVR_4 executing APP_B in SGR_2 as illustrated in FIG. 3.

However, the time for communication between servers performing work processes described in the applications depends on the physical locations of the servers. In other words, the communication time may possibly increase in the order of “within the same server”, “between server racks”, “between areas”, and “between bases”. In the case as in FIG. 3, communication is performed between server groups. Thus, if SVR_1 is selected first, SVR_2 is preferably selected next.

However, conventional technology does not consider the case where a plurality of applications are distributed over a plurality of servers and work processes described in applications are performed in cooperation as mentioned above.

It is preferable to provide a technology to relay communication for efficient processing.

### First Embodiment

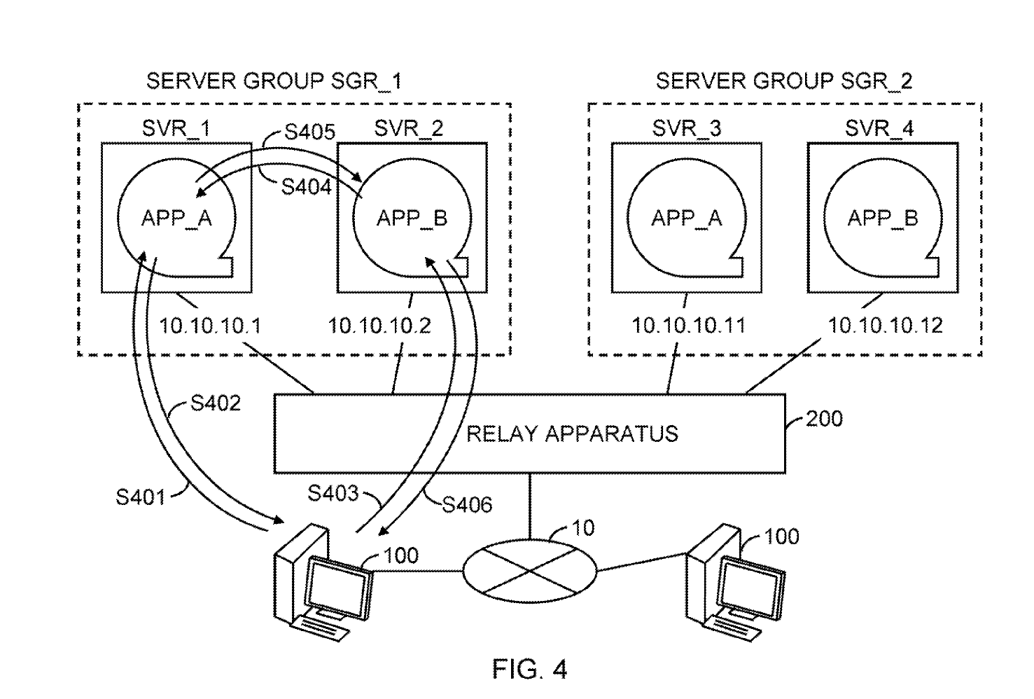

FIG. 4 illustrates an example of application cooperation according to a first embodiment of the present invention. A system according to the present embodiment will be discussed with reference to FIG. 4. As illustrated in FIG. 4, a plurality of client terminals 100 are connected to a relay apparatus 200 through a network 10, and a plurality of servers are connected to the relay apparatus 200. According to the present embodiment, a server group SGR_1 includes servers SVR_1 and SVR_2, and a server group SGR_2 includes servers SVR_3 and SVR_4. The servers within a server group are closely located, such as within one rack, one area/island or one base. According to the present embodiment, applications APP_A and APP_B describe work processes performed in cooperation, and the application group of APP_A and APP_B is provided in a plurality of server groups. Specifically, APP_A is provided in SVR_1 of SGR_1 and SVR_3 of SGR_2. APP_B is provided in SVR_2 of SGR_1 and SVR_4 of SGR_2. The number of applications which belong to an application group is not limited to two. In each of a plurality of server groups, a plurality of servers share and execute all applications which belong to an application group. The number of server groups is not limited to two either. It is supposed that a work process described in an application which belongs to an application group is not performed in cooperation with a work process described in an application which does not belong to the application group.

In the example illustrated in FIG. 4, it is assumed that the internet protocol (IP) address of SVR_1 is “10.10.10.1”, the IP address of SVR_2 is “10.10.10.2”, the IP address of SVR_3 is “10.10.10.11”, and the IP address of SVR_4 is “10.10.10.12”.

In S401, a user accesses SVR_1 from a client terminal 100.

In S402, SVR_1 performs the work process described in APP_A and returns a response to the client terminal 100.

In S403, the user accesses SVR_2 from the client terminal 100.

In S404, SVR_2 performs the work process described in APP_B and accesses SVR_1.

In S405, SVR_2 acquires necessary data from SVR_1.

In S406, SVR_2 performs the work process described in APP_B and returns a response to the client terminal 100.

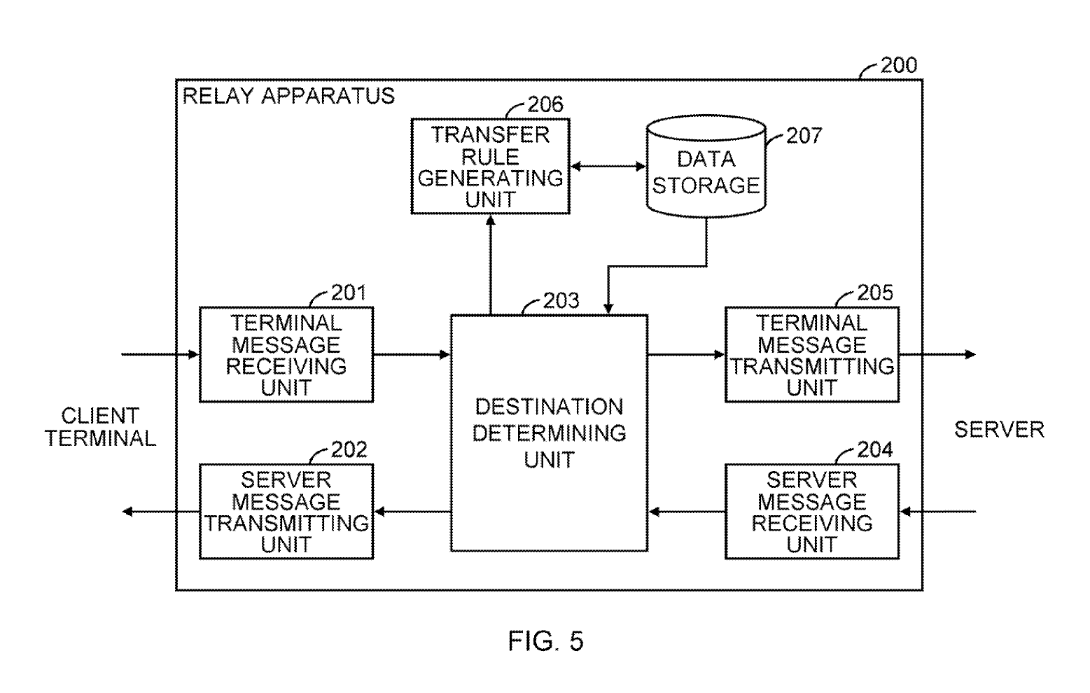

FIG. 5 illustrates a functional configuration of the relay apparatus 200 according to the present embodiment. The relay apparatus 200 includes a terminal message receiving unit 201 and server message transmitting unit 202 on the client terminal side, a server message receiving unit 204 and terminal message transmitting unit 205 on the server side, a data storage 207, a destination determining unit 203, and a transfer rule generating unit 206. The data storage 207 stores transfer rules and other data. On the basis of data stored in the data storage 207, the destination determining unit 203 causes the terminal message transmitting unit 205 to output a message received by the terminal message receiving unit 201 to a proper server and causes the server message transmitting unit 202 to output a message received by the server message receiving unit 204 to a proper client terminal 100. The transfer rule generating unit 206 generates a transfer rule by using data stored in the data storage 207 in accordance with an instruction received from the destination determining unit 203.

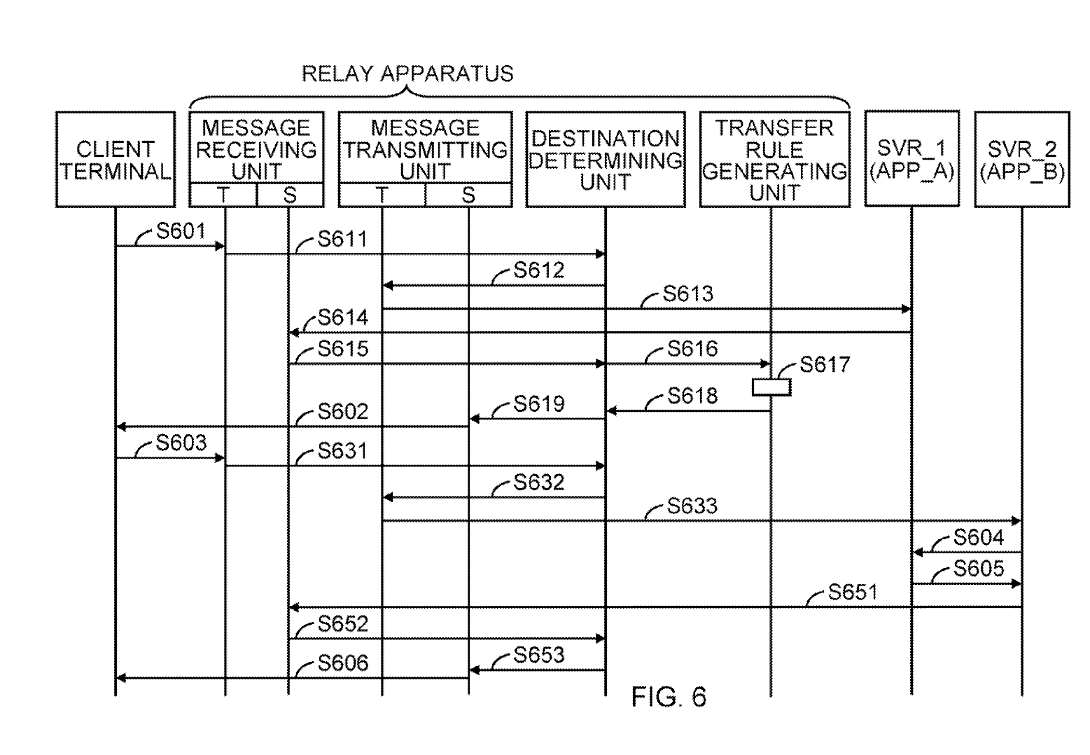

FIG. 6 illustrates an exemplary time sequence of a system according to the present embodiment. Operation flow of the system illustrated in FIG. 4 will be discussed with reference to FIGS. 6. S601 to S606 in FIG. 6 correspond to S401 to S406 in FIG. 4, respectively.

In S601, the client terminal 100 transmits a request for performing a work process PROC_A described in APP_A to the relay apparatus 200.

In S611, the terminal message receiving unit 201 of the relay apparatus 200 receives the request from the client terminal 100 and outputs the received request to the destination determining unit 203.

In S612, the destination determining unit 203 receives the request from the terminal message receiving unit 201. The destination determining unit 203 selects one server executing APP_A on the basis of an application execution data table stored in the data storage 207, as will be discussed below. The destination determining unit 203 instructs the terminal message transmitting unit 205 to transmit the received request to the selected server. For example, it is assumed that SVR_1 of SGR_1 is selected.

In S613, the terminal message transmitting unit 205 transmits the received request to the selected server in accordance with the instruction received from the destination determining unit 203. It is assumed that the received request is transmitted to SVR_1.

In S614, SVR_1 performing PROC_A receives the request from the relay apparatus 200. SVR_1 performs a predetermined process in response to the received request, generates a response thereto and transmits the generated response to the relay apparatus 200.

In S615, the server message receiving unit 204 of the relay apparatus 200 receives the response from SVR_1 and outputs the received response to the destination determining unit 203.

In S616, the response may contain a cookie, for example, and the cookie may contain a session ID. The destination determining unit 203 searches a transfer rule table stored in the data storage 207 with a session ID. If the session ID has not been registered, the destination determining unit 203 instructs the transfer rule generating unit 206 to generate a transfer rule.

In S617, the transfer rule generating unit 206 generates a transfer rule as will be discussed in detail below and registers the generated transfer rule with the transfer rule table stored in the data storage 207.

In S618, after generating the transfer rule, the transfer rule generating unit 206 notifies the destination determining unit 203 of the completion of the transfer rule generation.

In S619, the destination determining unit 203 instructs the server message transmitting unit 202 to transmit the response transmitted from SVR_1 to the requesting client terminal 100.

In S602, the server message transmitting unit 202 transmits the response to the requesting client terminal 100. Since the transfer of a response to a request to a requesting client terminal may be implemented as in conventional technologies, it will not be discussed in the present embodiment.

In S603, after receiving the response, the client terminal 100 generates a request for performing a work process PROC_B described in APP_B and transmits the generated request to the relay apparatus 200. The request contains the session ID contained in the received response.

In S631, the terminal message receiving unit 201 of the relay apparatus 200 receives the request from the client terminal 100 and outputs the received request to the destination determining unit 203.

In S632, the destination determining unit 203 searches the transfer rule table stored in the data storage 207 with the session ID and a uniform resource identifier (URI) regarding APP_B, both contained in the request, to find the corresponding transfer rule. Upon finding the corresponding transfer rule, the destination determining unit 203 reads, in accordance with the found transfer rule, data (such as an IP address and port number) regarding the destination server (supposed to be SVR_2 here) executing APP_B. The destination determining unit 203 instructs the terminal message transmitting unit 205 to transmit the request to the destination server SVR_2 determined in accordance with the transfer rule.

In S633, the terminal message transmitting unit 205 transmits, in accordance with the instruction, the received request to the destination server SVR_2 determined in accordance with the transfer rule.

In S604, SVR_2 performing PROC_B receives the request from the relay apparatus 200 and performs a predetermined process in response to the received request. In this case, SVR_2 accesses, by using the session ID, SVR_1 to request data regarding the result of the preceding process.

In S605, SVR_1 transmits the requested data to SVR_2. Since the message exchange between SVR_1 and SVR_2 may be performed in a conventional manner, it will not be discussed here in further detail.

In S651, upon completing the process, SVR_2 performing PROC_B generates a response and transmits the generated response to the relay apparatus 200.

In S652, the server message receiving unit 204 of the relay apparatus 200 receives the response from SVR_2 and outputs the received response to the destination determining unit 203.

In S653, the destination determining unit 203 searches the transfer rule table stored in the data storage 207 with the session ID contained in the received response. When a corresponding transfer rule exists in the transfer rule table, the generation of a transfer rule is not performed. Thus, the destination determining unit 203 instructs the server message transmitting unit 202 to transmit the received response to the requesting client terminal 100.

In S606, the server message transmitting unit 202 transmits the received response to the requesting client terminal 100 in accordance with the instruction.

Performing this process may generate a transfer rule for the response to the first request. Therefore, succeeding requests for performing PROC_A and PROC_B may be transferred immediately to the servers which belong to the same server group. In the example discussed above, a request for performing PROC_B is transmitted after the request for performing PROC_A. However, the request for performing PROC_B may be transmitted after the requests for performing PROC_A are transmitted many times. Alternatively, after the request for performing PROC_B is transmitted, the request for performing PROC_A may be transmitted again. The present embodiment may address the both cases.

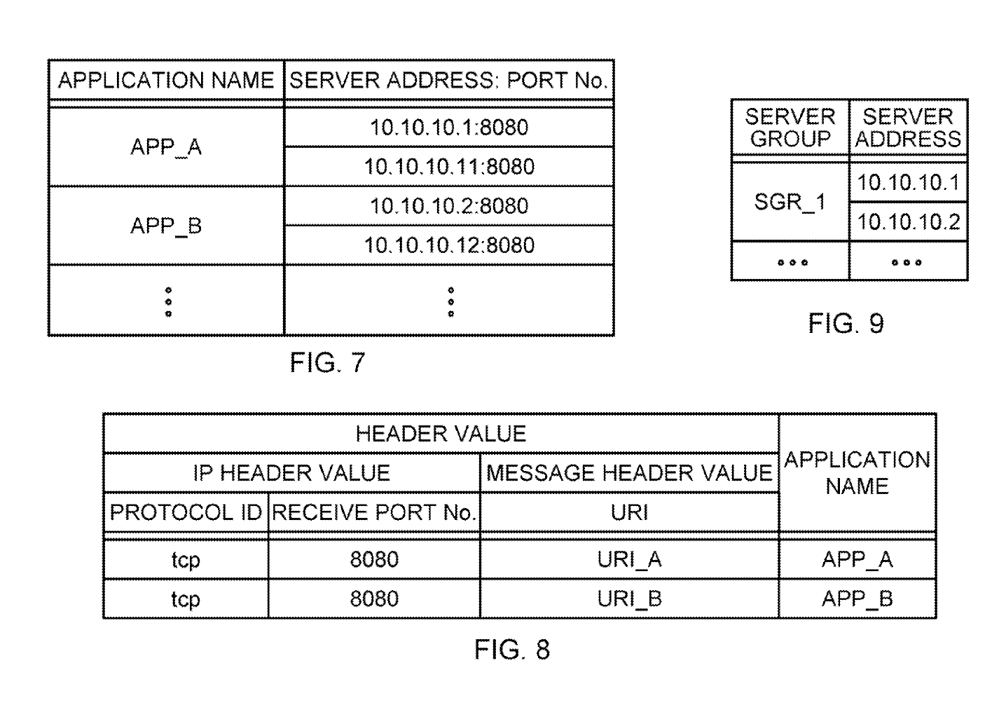

Next, details of the operations of the relay apparatus 200 will be discussed with reference to FIG. 7 to FIG. 13. FIG. 7 illustrates an example of an application execution data table according to the present embodiment. The data storage 207 stores an application execution data table as illustrated in FIG. 7. In the example illustrated in FIG. 7, an IP address (referred to as a server address) and port number of a server which is executing an application are stored, for each application, in association with the name of the application. APP_A is associated with the IP address and port number “10.10.10.1:8080” of SVR_1 and the IP address and port number “10.10.10.11:8080” of SVR_3. APP_B is associated with the IP address and port number “10.10.10.2:8080” of SVR_2 and the IP address and port number “10.10.10.12:8080” of SVR_4.

FIG. 8 illustrates an example of an application name acquisition table according to the present embodiment. The data storage 207 further stores an application name acquisition table as illustrated in FIG. 8. In the example illustrated in FIG. 8, the table has a correspondence relationship between the header value of a message and an application name. The header value is a combination of an IP header value and a message header value. The IP header value contains a protocol ID and a receive port number. The message header value contains a URI. For example, APP_A is acquired when the protocol is transmission control protocol (tcp), the receive port number is “8080”, and the URI is “URI_A”. Conversely, the URI is “URI_A” and the port number is “8080” for APP_A. Similarly, APP_B is acquired when the protocol is tcp, the receive port number is “8080”, and the URI is “URI_B”.

FIG. 9 illustrates an example of a server group table according to the present embodiment. The data storage 207 further stores a server group table as illustrated in FIG. 9. In the example illustrated in FIG. 9, the identifier of a server group and an IP address of servers which belong to the server group are stored for each server group. For example, the order of the server addresses may be determined and registered in accordance with the execution order of APP_A and APP_B.

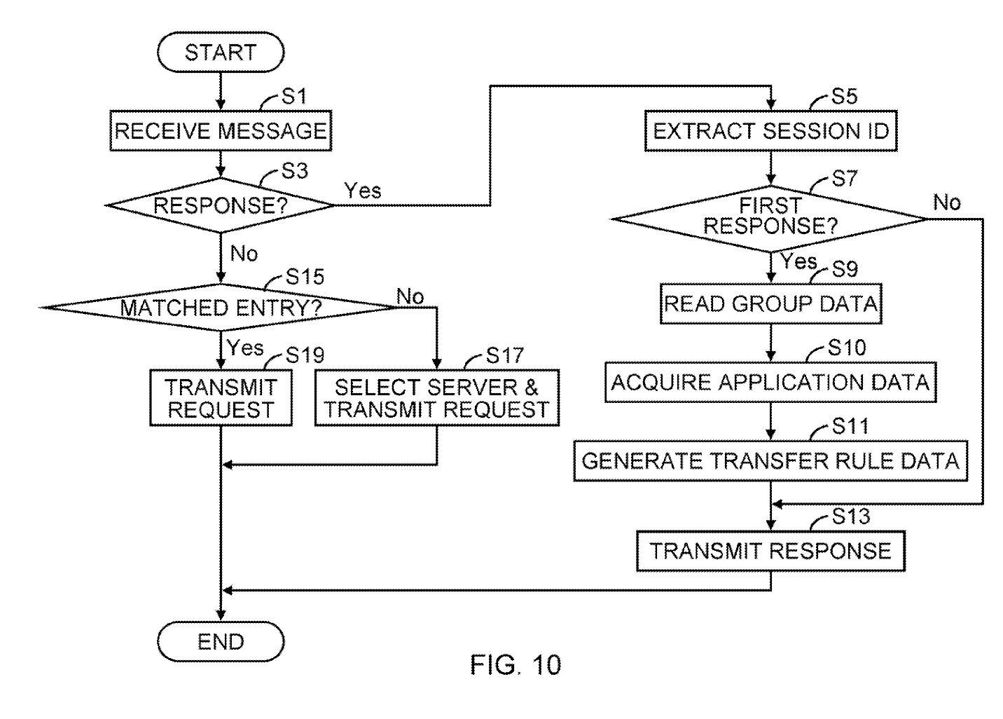

FIG. 10 illustrates an exemplary operation flow of the relay apparatus 200 under this condition. This process is performed every time the relay apparatus 200 receives a request or response.

In S1, the destination determining unit 203 receives a message from the terminal message receiving unit 201 or server message receiving unit 204.

In S3, the destination determining unit 203 determines whether the received message is a response or not. The destination determining unit 203 determines, for example, whether it is a hypertext transfer protocol (HTTP) response or not on the basis of the header of the message.

In S5, when the received message is a response (“Yes” in S3), the destination determining unit 203 extracts the session ID from the response.

In S7, the destination determining unit 203 determines whether it is a response to a first request or not. That is, the destination determining unit 203 searches the transfer rule table stored in the data storage 207. When no corresponding entry exists (“Yes” in S7), the destination determining unit 203 determines that the received response is a response to a first request and outputs a transfer rule generation instruction containing the session ID and the received response to the transfer rule generating unit 206. Thereafter, the relay apparatus 200 advances the process to S9. On the other hand, when the transfer rule table has a corresponding entry (“No” in S7), the generation of a new transfer rule is not performed. Thus, the relay apparatus 200 advances the process to S13.

In S9, the transfer rule generating unit 206 receives the transfer rule generation instruction and searches the server group table with the source server address contained in the response to read data (referred to as own group data) regarding the server group (referred to as own server group) to which the source server belongs. The own group data contains IP addresses of the servers which belong to the own server group. In the example illustrated in FIG. 9, the transfer rule generating unit 206 reads “10.10.10.1” and “10.10.10.2”.

In S10, the transfer rule generating unit 206 acquires data (referred to as application data) regarding the application. Specifically, the transfer rule generating unit 206 may search the application execution data table (FIG. 7) with the read server address to read the application name. The transfer rule generating unit 206 may further search the application name acquisition table (FIG. 8) with the read application name to read the corresponding URI, for example. As will be discussed below, the transfer rule generating unit 206 may acquire only the application name.

When a set of applications may be acquired from another correspondence table on the basis of the identifier of the server group, or when there is only one group of applications, the transfer rule generating unit 206 reads the names and URIs of applications included in the group of the applications from the application name acquisition table (FIG. 8). The transfer rule generating unit 206 may read a port number from the application name acquisition table (FIG. 8), for example. In the case of a web service, since the port number is normally “8080”, the transfer rule generating unit 206 may fix the port number as to be “8080”. Referring to the examples in FIG. 7 to FIG. 9, the transfer rule generating unit 206 acquires the application name “APP_A”, the URI “URI_A” and the port number “8080” as the application data for the server address “10.10.10.1”. The transfer rule generating unit 206 acquires the application name “APP_B”, the URI “URI_B” and the port number “8080” as the application data for the server address “10.10.10.2”.

In S11, the transfer rule generating unit 206 generates transfer rule data on the basis of the application data, session ID and the own group data and registers the generated transfer rule data with the transfer rule table.

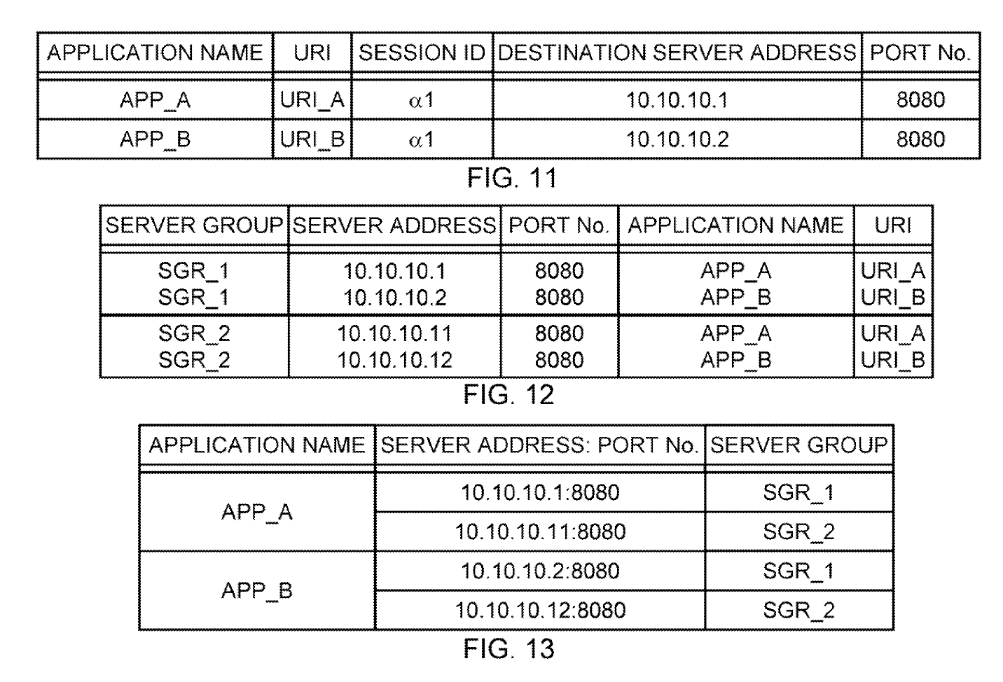

FIG. 11 illustrates an example of a transfer rule table according to the present embodiment. In the example illustrated in FIG. 11, an application name, a URI, a session ID, a destination server address, and a port number are registered with a transfer rule table. Preparing the application name acquisition table (FIG. 8) allows acquisition of an application name from the corresponding URI. Thus, even when the transfer rule does not contain the URI, the corresponding entry may be acquired on the basis of the application name and session ID. When a URI is registered with the transfer rule table, the corresponding entry may be acquired on the basis of the URI and session ID contained in a request.

As illustrated in FIG. 11, the destination server address “101010.1” which is a server address, an application name “APP_A”, URI “URI_A” and a port number “8080” are registered in association with a session ID “α1”. In the same manner, a destination server address “10.10.10.2”, application name “APP_B”, URI “URI_B” and port number “8080” are registered in association with the session ID “α1”.

Preparing entries for a group of applications allows quick access to the same server even when the application executed first is invoked many times. It further allows quick access to another server which belongs to the same server group in order to execute another application which belongs to the same application group.

In S13, the transfer rule generating unit 206 notifies the destination determining unit 203 of the completion of the transfer rule generation. In response to it, the destination determining unit 203 causes the server message transmitting unit 202 to transmit the received response to the requesting client terminal 100. Thereafter, the relay apparatus 200 terminates the process.

In S15, when it is determined that the received message is not a response but a request (“No” in S3), the destination determining unit 203 reads the session ID and URI from the received request, and searches the transfer rule table stored in the data storage 207 with the session ID and URI (or the application name) to determine whether any matched entry exists in the transfer rule table or not.

In S19, when the matched entry exists (“Yes” in S15), it means that the received request is the second or later request. Thus, the destination determining unit 203 causes the terminal message transmitting unit 205 to transmit the received request destined to the IP address and port number contained in the matched entry of the transfer rule. Thereafter, the relay apparatus 200 terminates the process.

As discussed above, if the entry of the transfer rule table does not contain a URI, the application name may be acquired from the application name acquisition table (FIG. 8) on the basis of the URI, allowing the search through the transfer rule table with the acquired application name.

In this way, the second and later request may be transferred quickly to a server which belongs to the same server group.

In S17, when no matched entry exists in the transfer rule table (“No” in S15), it means that the received request is the first request. Thus, the destination determining unit 203 reads the application name from the application name acquisition table on the basis of the URI (specifically, the protocol ID, port number and URI) contained in the request. The destination determining unit 203 searches the application execution data table (FIG. 7) with the application name and extracts the IP addresses and port numbers of the corresponding servers. This results in the identification of the servers executing the application requested by the client terminal 100. The destination determining unit 203 selects one specific server from the identified servers in accordance with a predetermined algorithm (such as a round robin) and causes the terminal message transmitting unit 205 to transmit the received request destined to the IP address and port number of the specific server.

Performing the process as discussed above allows proper generation of a transfer rule table and quick identification of a proper destination server for the second or later request.

The configurations of the tables illustrated in FIG. 7 to FIG. 9 may be changed variously. FIG. 12 illustrates an example of a merged table according to the present embodiment. For example, a table (referred to as a merged table) as illustrated in FIG. 12 may be prepared. The merged table illustrated in FIG. 12 stores, for each server group, the IP addresses and port numbers of the servers which belong to the each server group and the application names and URIs of applications executed by the servers. The merged table may also store the corresponding protocol IDs. A data table such as the merged table allows acquisition of the IP address and port number of a server executing the requested application on the basis of the URI even when a request is received first and allows selection of one of the servers. When a response to the first request is received, the IP address and port number, application name and URI of a server which belongs to the server group to which the source server belongs may be read on the basis of the source server address. Thus, the transfer rule entry may be generated.

FIG. 13 illustrates an example of another merged table according to the present embodiment. The another merged table illustrated in FIG. 13 stores a name of an application, an IP address and port number of a server executing the application, and an identifier of a server group to which the server belongs are stored in association. A data table such as the another merged table allows acquisition of the IP addresses and port numbers of the servers executing the same application and further allows identification of a server group to which the servers belongs on the basis of the IP addresses and port numbers of the identified servers. Thus, the IP addresses and port numbers of other servers which belong to the server group may further be acquired.

Though the application names are prepared separately from the URI in the example, the URI may be used as an application name.

### Second Embodiment

According to a second embodiment, a plurality of application groups are provided. Furthermore, a specific application may belong to a plurality of application groups. For example, it is supposed that APP_A is an application executed at a quotation site for a personal computer (PC), APP_B is an application executed at a payment site, and APP_C is an application executed at a quotation site for a network apparatus. It is also supposed that a first application group includes APP_A and APP_B, and a second application group includes APP_C and APP_B. In this case, APP_B is shared by the first and second application groups.

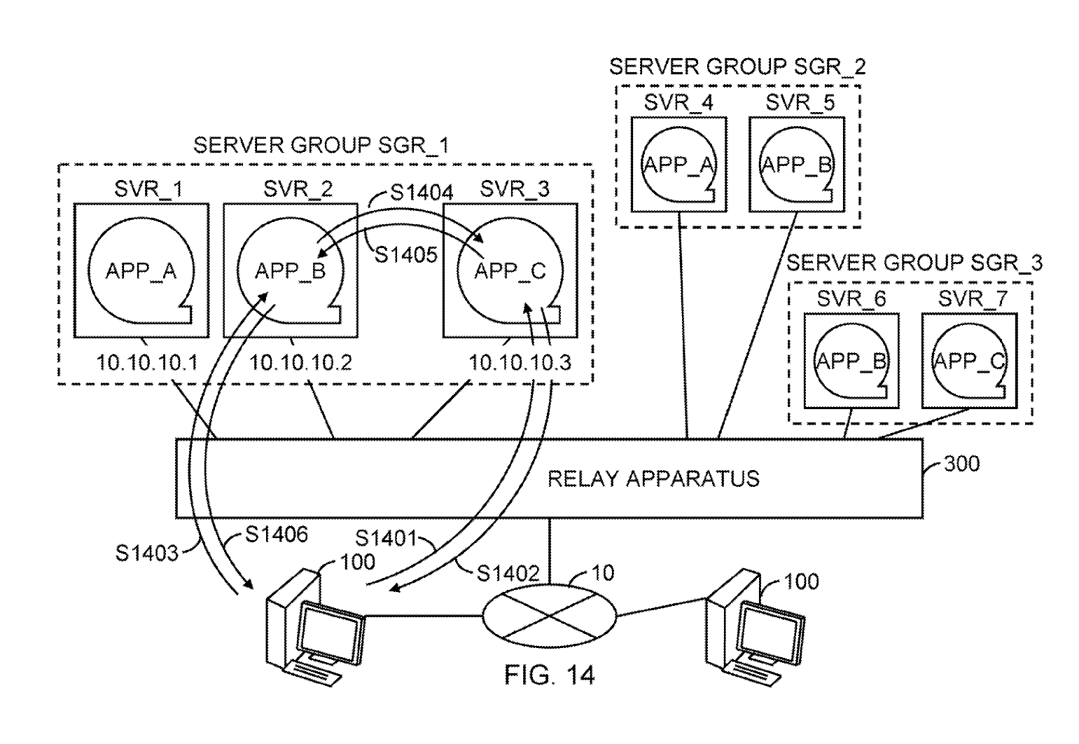

FIG. 14 illustrates an example of application cooperation according to the present embodiment. A system according to the present embodiment will be discussed with reference to FIG. 14. As illustrated in FIG. 14, a plurality of client terminals 100 are connected to a relay apparatus 300 through a network 10, and a plurality of servers are connected to the relay apparatus 300. According to the present embodiment, a server group SGR_1 includes servers SVR_1 to SVR_3, a server group SGR_2 includes servers SVR_4 and SVR_5, and a server group SGR_3 includes servers SVR_6 and SVR_7. The servers within a server group are closely located, such as within one rack, one area/island or base. SVR_1 executes APP_A, SVR_2 executes APP_B, SVR_3 executes APP_C, SVR_4 executes APP_A, SVR_5 executes APP_B, SVR_6 executes APP_B, and SVR_7 executes APP_C. In this case, in SGR_1, the first application group and the second application group may be executed. On the other hand, only the first application group may be executed in SGR_2, and only the second application group may be executed in SGR_3.

The operations of the system is similar to the one discussed with reference to FIG. 6. S1401 to S1406 in FIG. 14 correspond to S601 to S606 in FIG. 6.

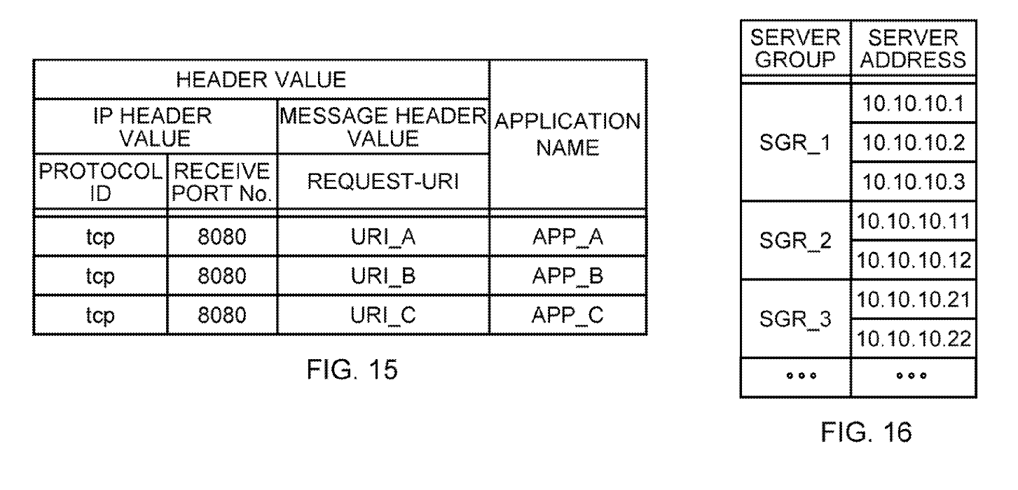

In this system, the relay apparatus 300 is functionally similar to the relay apparatus 200 according to the first embodiment illustrated in FIG. 5 except for the operations of the transfer rule generating unit 206 and the data stored in data storage 207. Details of stored data will be discussed with reference to FIG. 15 to FIG. 18. For convenience of discussion, like numbers in FIG. 5 refer to like components.

FIG. 15 illustrates an example of an application name acquisition table according to the present embodiment. The data structure is similar to the one illustrated in FIG. 8. Since APP_C is further provided in the present embodiment, data regarding APP_C is further added.

FIG. 16 illustrates an example of a server group table according to the present embodiment. The data structure is similar to the one illustrated in FIG. 9. There are three server groups as illustrated in FIG. 14. Thus, the server group tables store IP addresses of the servers which belong to the three server groups.

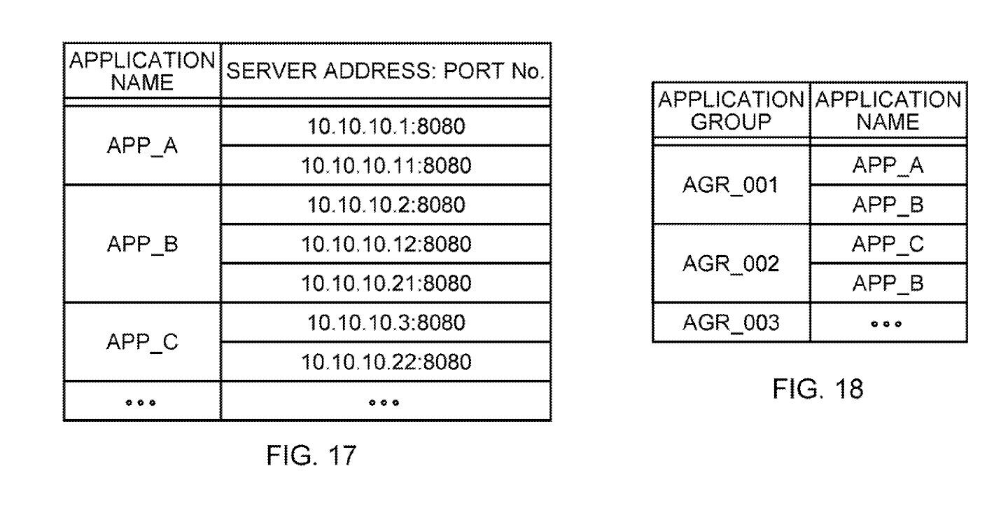

FIG. 17 illustrates an example of an application execution data table according to the present embodiment. The data structure is similar to the one illustrated in FIG. 7. However, the application execution data table stores IP addresses and port numbers of servers for APP_A to APP_C. Since APP_B is executed in cooperation with APP_A or APP_C, a server for executing APP_B is prepared in each of the server groups SGR_1 to SGR_3.

According to the present embodiment, an application group table which is not used in the first embodiment is used. FIG. 18 illustrates an example of an application group table according to the present embodiment. In the example illustrated in FIG. 18, the name of an application is stored in association with the identifier of an application group to which the application belongs. As discussed above, APP_A and APP_B belong to a first application group AGR_001, and APP_C and APP_B belong to a second application group AGR_002.

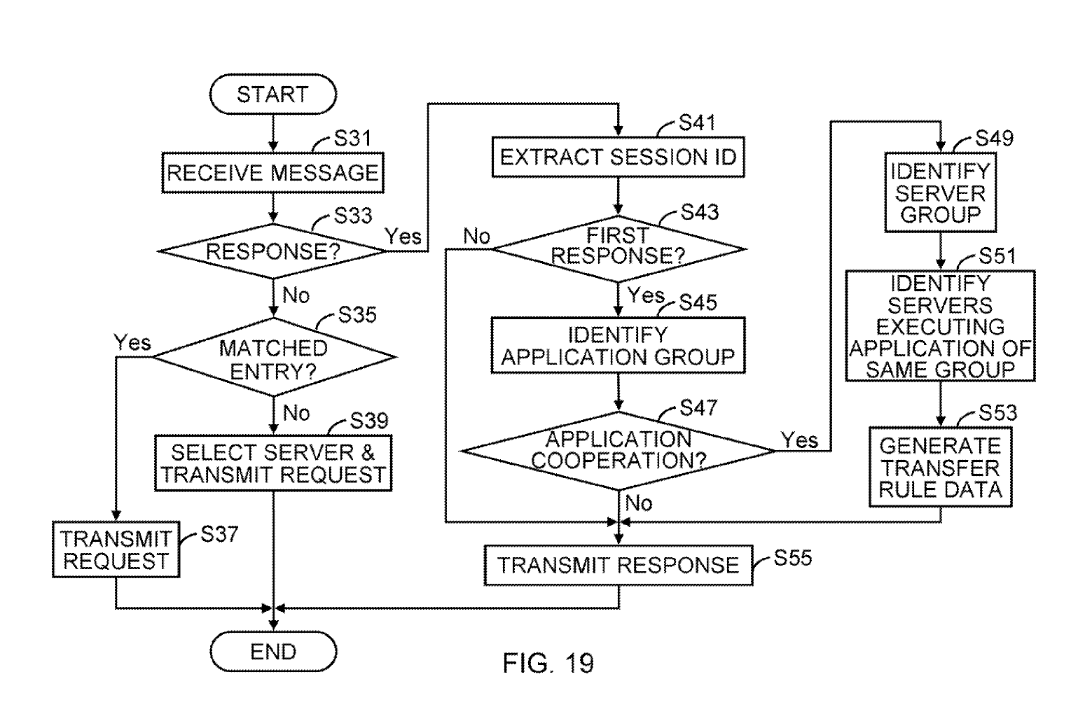

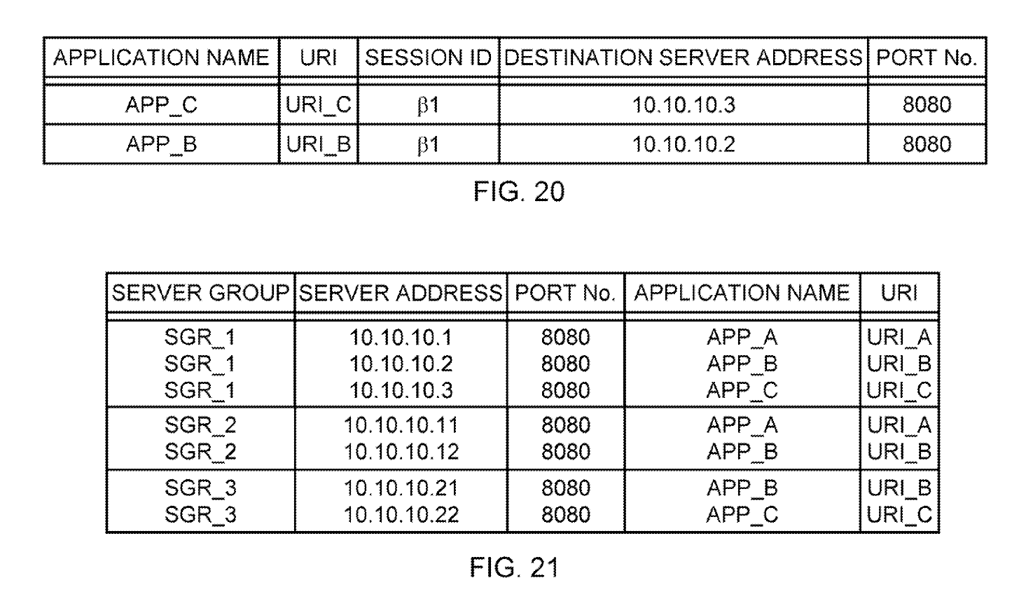

Next, details of operations of the relay apparatus 300 will be discussed with reference to FIG. 19 to FIG. 20.

FIG. 19 illustrates an exemplary operation flow of a relay apparatus according to the present embodiment.

In S31, the destination determining unit 203 receives a message from the terminal message receiving unit 201 or server message receiving unit 204.

In S33, the destination determining unit 203 determines whether the received message is a response or not. The destination determining unit 203 determines, for example, whether it is an HTTP response or not on the basis of the header of the message.

In S41, when the received message is a response (“Yes” in S33), the destination determining unit 203 extracts the session ID from the response.

In S43, the destination determining unit 203 determines whether it is a response to a first request or not. That is, the destination determining unit 203 searches the transfer rule table stored in the data storage 207. When no corresponding entry exists, the destination determining unit 203 determines that the received response is a response to a first request (“Yes” in S43) and outputs a transfer rule generation instruction containing the session ID and the received response to the transfer rule generating unit 206. Thereafter, the relay apparatus 200 advances the process to S45. On the other hand, when the transfer rule table has a corresponding entry (“No” in S43), the generation of a new transfer rule is not performed. Thus, the relay apparatus 200 advances the process to S55.

In S45, the transfer rule generating unit 206 receives the transfer rule generation instruction and searches the application execution data table (FIG. 17) with the IP address and port number of the source server contained in the response to read the application name. Then, the transfer rule generating unit 206 searches the application group table (FIG. 18) with the read application name to identify the corresponding application group. For example, the transfer rule generating unit 206 may acquire the application name “APP_C” by searching the application execution data table with the IP address “10.10.10.3” and port number “8080”. The transfer rule generating unit 206 may identify the application group AGR_002 by searching the application group table (FIG. 18) with the application name “APP_C”. Thus, the transfer rule generating unit 206 may acquire the application names “APP_B” and “APP_C” of the applications included in the application group AGR_002.

In S47, the transfer rule generating unit 206 determines whether the application cooperation is performed or not. When the transfer rule generating unit 206 has identified the application group, it means that the application cooperation is performed. When the transfer rule generating unit 206 searches the application group table with an application name of an application which is not executed in cooperation with another application, the transfer rule generating unit 206 may identify no application group.

When the application cooperation is not performed (“No” in S47), the relay apparatus 200 advances the process to S55.

In S49, when the application cooperation is performed (“Yes” in S47), the transfer rule generating unit 206 searches the server group table (FIG. 16) with the IP address of the source server contained in the response to read the IP addresses of the servers which belong to the same server group.

For example, the transfer rule generating unit 206 may identify the server group SGR_1 by searching the server group table (FIG. 16) with “10.10.10.3”. Thus, the transfer rule generating unit 206 may acquire the IP addresses “10.10.10.1”, “10.10.10.2” and “10.10.10.3” of the servers which belong to the server group SGR_1.

In S51, the transfer rule generating unit 206 acquires the IP addresses and port numbers of servers which execute the applications which belong to the corresponding application group and belong to the corresponding server group. The transfer rule generating unit 206 has already acquired the IP address “10.10.10.3” and port number “8080” of the server which executes the application APP_C. The transfer rule generating unit 206 identifies servers which belong to the corresponding server group SGR_1 and execute the different application APP_B which belongs to the same application group AGR_002. Thus, the transfer rule generating unit 206 searches the application group table (FIG. 18) with the application name “APP_B” to acquire the IP addresses and port numbers of the servers. In this case, the transfer rule generating unit 206 extracts “10.10.10.2:8080”, “10.10.10.12:8080” and “10.10.10.22:8080”. Among them, the transfer rule generating unit 206 may select “10.10.10.2:8080” which has the same IP address “10.10.10.2” acquired in S49 above.

In S53, the transfer rule generating unit 206 searches the application name acquisition table (FIG. 15) with the application name to read the corresponding URI as application data. The transfer rule generating unit 206 generates transfer rule data on the basis of the application data, the session ID contained in the response, and the IP address and port number of the selected server. The transfer rule generating unit 206 registers the generated transfer rule data with the transfer rule table stored in the data storage 207. FIG. 20 illustrates an example of a transfer rule table according to the present embodiment. The transfer rule table has similar data structure to the one according to the first embodiment but includes an entry of the application name “APP_C”, URI “URI_C”, session ID “β1”, destination server IP address “10.10.10.3” and port number “8080” and an entry of the application name “APP_B”, URI “URI_B”, session ID “β1”, destination server IP address “10.10.10.2” and port number “8080”.

Thus, upon receiving a request for executing APP_C and APP_B, the relay apparatus 200 may transfer the request quickly to proper servers which belong to the same server group.

Like the first embodiment, even if the entry of the transfer rule table does not contain a URI, the corresponding entry may be identified because the application name may be acquired from the application name acquisition table (FIG. 15) on the basis of the URI. If a URI is registered, the corresponding entries may be identified even if the application name is not registered.

In S55, The transfer rule generating unit 206 notifies the destination determining unit 203 of the completion of the transfer rule generation. The destination determining unit 203 causes the server message transmitting unit 202 to transmit the received response to the requesting client terminal 100. Thereafter, the relay apparatus 200 terminates the process.

In S35, when it is determined that the received message is not a response but a request (“No” in S33), the destination determining unit 203 reads the session ID and URI from the received request and searches the transfer rule table (FIG. 20) stored in the data storage 207 with the session ID and URI (or the application name) to determine whether any matched entry exists in the transfer rule table or not.

In S37, when the matched entry exists (“Yes” in S35), it means that the received request is the second or later request. Thus, the destination determining unit 203 causes the terminal message transmitting unit 205 to transmit the received request destined to the IP address and port number contained in the matched entry of the transfer rule. Thereafter, the relay apparatus 200 terminates the process.

As discussed above, if the entry of the transfer rule table does not contain a URI, the application name may be acquired from the application name acquisition table (FIG. 15) on the basis of the URI, allowing the search through the transfer rule table with the acquired application name.

In this way, the second and later requests may be transferred quickly to a server which belongs to the same server group.

In S39, when no matched entry exists in the transfer rule table (“No” in S35), it means that the received request is the first request. Thus, the destination determining unit 203 reads the application name from the application name acquisition table on the basis of the URI (specifically, the protocol ID, port number and URI) contained in the request. The destination determining unit 203 searches the application execution data table (FIG. 17) with the application name and extracts the IP addresses and port numbers of the corresponding servers. This results in the identification of servers executing the application requested by the client terminal 100. The destination determining unit 203 selects one specific server from identified servers in accordance with a predetermined algorithm (such as a round robin) and causes the terminal message transmitting unit 205 to transmit the received request destined to the IP address and port number of the specific server.

Performing the process as discussed above allows proper generation of a transfer rule table and quick identification of a proper destination server for the second or later request.

The use of the application group table may allow flexible identification of various application groups defined for a server group.

The data stored in the data storage 207 may be changed variously. As discussed in the first embodiment, the data in FIG. 15 to FIG. 17 may be merged. FIG. 21 illustrates an example of a merged table according to the present embodiment. For example, a merged table as illustrated in FIG. 21 may be prepared. When the merged table as illustrated in FIG. 21 is searched with the IP address and port number contained in the response, the corresponding application name and URI may be acquired and also the IP addresses, port numbers, application names and URIs of other servers which belong to the same server group may be acquired. When the application group table is searched with the application name, application names of other applications which belong to the same application group may be acquired. Thus, among other servers which belong to the same server group, servers executing the identified other applications may be narrowed and the IP addresses, port numbers and URIs of the narrowed servers may be acquired.

Also as discussed in the first embodiment, the data in FIG. 16 and FIG. 17 may be merged. In other words, the data structure as illustrated in FIG. 13 may be used. Any data structure may be used if data regarding servers which execute applications which belong to the same application group and belong to the same server group may be extracted, like the transfer rule table.

Instead of the application name, the URI may be used as the identifier of an application in a unified manner.

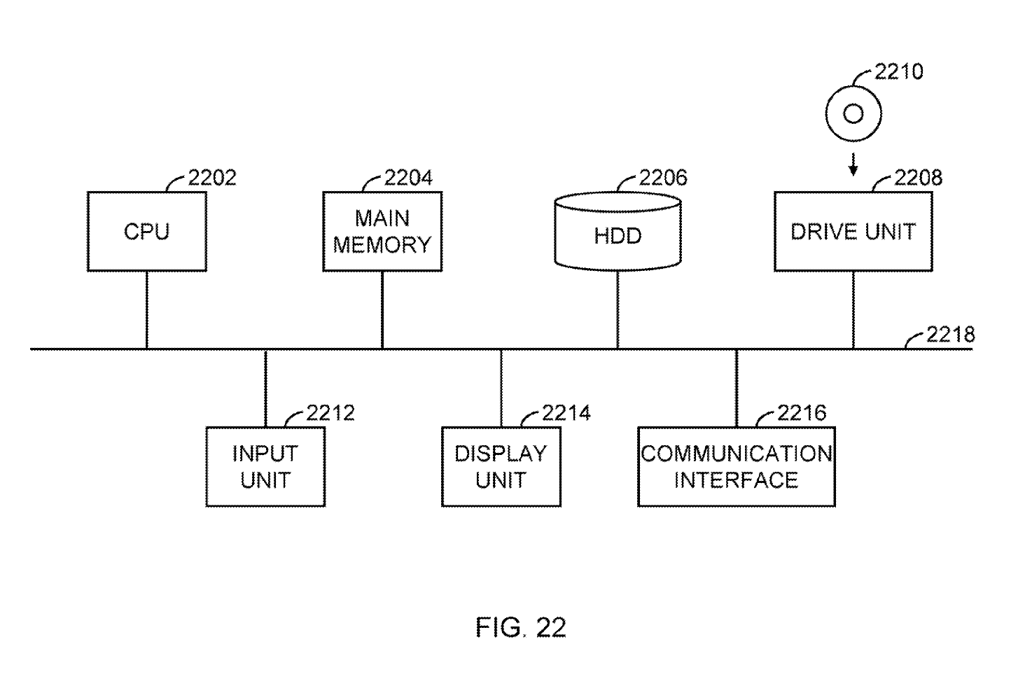

The embodiments are not limited to those discussed above. For example, the functional configuration illustrated in FIG. 5 is given for illustration purpose only and may not typically agree with the actual module configuration. For example, the destination determining unit 203 and transfer rule generating unit 206 may be implemented by a combination of a processor of a computer and a program which causes the processor to perform processes as discussed above. FIG. 22 illustrates an exemplary configuration of a computer. The computer illustrated in FIG. 22 includes a central processing unit (CPU) 2202 for executing software such as operating system (OS) and application programs, a main memory 2204 such as a random access memory (RAM) for temporarily storing data, an auxiliary storage such as a hard disk drive (HDD) 2206 for storing data, a drive unit 2208 for reading data from and/or writing data to a removable disk 2210, an input unit 2212 for accepting user input, a display unit 2214 for displaying data, and a communication interface 2216 for establishing a connection to a network. These components are connected to each other via a bus 2218. The software may be stored in the removable disk 2210 when delivered, installed onto the HDD 2206 from the removable disk 2210, and loaded into the main memory 2204 from the HDD 2206 when executed by the CPU 2202. The software may be delivered over the network. In this case, the program may be stored in a read only memory (ROM) or flash memory, for example, and may be read and executed by the CPU. The data storage 207 may be implemented by a semiconductor memory, for example.

The operation flows may be implemented in a different order or in parallel as far as the same results may be provided.

Having discussed the example in which a plurality of physical servers exist, a part or all of servers may be implemented as virtual machines (VMs) on one or a plurality of physical servers. Also in this case, the same processes may be performed by the relay apparatus.

The aforementioned embodiments may be summarized as follows:

According to an embodiment, a relay processing method is executed by a relay apparatus to which a plurality of groups of servers sharing and executing a plurality of application programs are connected. The relay processing method includes: (A) receiving from a specific server a response to a first request transmitted from a specific client terminal; (B) acquiring, on the basis of the address of the specific server contained in the response, the addresses of servers which belong to a specific group to which the specific server belongs to and at least one of the identifiers and URIs of application programs executed by the servers; (C) storing, in association with the session identifier contained in the response, the addresses of the servers which belong to the specific group and at least one of the identifiers and URIs of the application programs executed in the servers in a transfer rule data storage; and (D) acquiring, upon receiving a second request containing a session identifier and specific URI from the specific client terminal, the address of the destination server of the second request from the transfer rule data storage on the basis of the session identifier and specific URI, and transmitting the second request to the address of the destination server.

The transfer rule generated in this way allows transfer of a subsequent request to a server which is executing an application requested in the subsequent request and which belongs to the same server group as the server group to which the server having processed the immediately preceding request belongs. If the servers within a server group are close in distance, communication may be performed in a short period of time even when data takeover occurs between servers. Thus, the time until the transmission of a response thereto may be reduced. In other words, efficient cooperation between servers executing applications may be provided.

(B) of the relay processing method may include: (B1) acquiring, on the basis of the address of a specific server contained in the response, the address of another server of the group to which the specific server belongs from a first data storage (such as a server group table) which stores, for each server group, addresses of servers which belong to the server group; and (B2) reading at least one of the identifier and URI of an application program from a second data storage (such as an application name acquisition table) which stores at least one of the identifier and URI of an application program included in a set of application programs. For example, this process may generate a transfer rule when one application program set is provided in the range of servers for which the transfer rule is to be generated. If the group of the application may be identified by the identifier of the server group, a plurality of application program sets may be handled.

When a plurality of application program sets exist, the relay processing method may include: (B11) acquiring, on the basis of the IP address of a specific server contained in a response, the IP address of another server of the server group to which the specific server belongs from a third data storage (such as a server group table) which stores, for each server group, IP addresses of servers which belong to the server group; (B12) acquiring, on the basis of the IP address and port number of a specific server contained in a response, the identifier of an application program executed in the specific server from a fourth data storage (such as an application execution data table) which stores, for each application program, the identifier of the application program in association with the IP address and port number of a server executing the application program; (B13) acquiring, on the basis of the identifier of the identified application program, the identifier of another application program in which belongs to the set to which the identified application program belongs from a fifth data storage (such as an application group table) which stores for each of the sets, the identifiers of application programs which belong to the set; and (B14) acquiring, on the basis of the identifier of the identified other application program and the IP address and port number of the identified other server, the IP address and port number of a server which is executing another application program and belongs to the group to which the specific server belongs from the fourth data storage.

The use of the fifth data storage may allow to address flexibly the case where a plurality of kinds of application program sets exist. The narrowing by B14 may be optional. The order of B11 and B12 may be reversed.

When a plurality of application program sets exist, the relay processing method may include: (B21) acquiring, on the basis of the IP address and port number of the specific server contained in a response, the identifier of an application program which executed in the specific server and the identifier of the server group to which the specific server belongs from a sixth data storage (such as a merged table illustrated in FIG. 13) which stores, for each application program, the identifier of the application program in association with the IP address and port number of a server which is executing the application program and the identifier of the server group to which the server belongs; (B22) acquiring, on the basis of the identifier of the identified application program, the identifier of another application program in which belongs to the set to which the identified application program belongs from a fifth data storage (such as an application group table) which stores, for each of the sets, the identifiers of application programs which belong to the set; and (B23) reading, on the basis of the identifier of the identified other application program and the identifier of the server group to which the specific server belongs, the IP address and port number of the server associated with the identifier of the other application program and the identifier of the server group to which the specific server belongs from the sixth data storage. By using a merged table as illustrated in FIG. 13, this process may provide data for transfer rule generation.

When a plurality of application program sets exist, the relay processing method may further include: reading URIs corresponding to the identifiers of an application program executed in a specific server and the identified other application program from a seventh data storage (such as an application name acquisition table) which stores data regarding a correspondence relationship between a URI and the identifier of an application program. Since a request contains a URI, containing the URI in a transfer rule allows quick identification of a destination server in processing a request.

(D) of the relay processing method may include: acquiring the identifier of an application program corresponding to a specific URI contained in a second request from a seventh data storage (such as an application name acquisition table) which stores data regarding a correspondence relationship between a URI and the identifier of an application program. If a URI is not contained in a transfer rule, for example, the identifier (such as the name) of an application may be acquired by the URI in that way, and the transfer rule may thus identified.

According an embodiment, a relay apparatus includes: a receiving portion which receives, from a specific server of a plurality of groups of servers sharing and executing a set of application programs, a response to a first request transmitted from a specific client terminal, a transfer rule data storage, a transfer rule generating unit which acquires the addresses of servers which belong to a specific server group to which the specific server belongs and at least one of identifiers and URIs of application programs executed by the servers and stores in the transfer rule data storage the acquired data in association with a session identifier contained in the response, and a destination determining unit which, upon receiving a second request containing a session identifier and specific URI from the specific client terminal, acquires the address of the destination server of the second request from the transfer rule data storage on the basis of the session identifier and specific URI and transmits the second request to the address of the destination server.

A program causing a processor to perform the aforementioned process may be generated. The program may be stored in a computer-readable medium or storage device such as a flexible disk, a compact disc (CD) ROM (CD-ROM), a digital versatile disc (DVD) ROM (DVD-ROM), a blu-ray disc (BD) ROM (BD-ROM), a magneto-optical disk, a semiconductor memory (such as a ROM and a flash memory), and a hard disk. The data being processed are temporarily stored in a storage device such as an RAM.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been discussed in detail, it should be understood that the various changes, substitutions, and alterations could be made hereto without departing from the spirit and scope of the invention.

What is claimed is:

1. A relay method executed by a relay apparatus connected to a plurality of servers and a client to relay a message transmitted from the client to one of the plurality of servers, the relay method comprising:
receiving from one of the plurality of servers a response to a first message transmitted from the client;
storing in a data storage a first server identifier in association with a first session identifier included in the response, the first server identifier being for identifying the one of the plurality of servers that has transmitted the response;
extracting, upon receiving a second message transmitted from the client, a second server identifier from the data storage on the basis of a second session identifier included in the second message, the second server identifier being for identifying an advance server;
determining, by the relay apparatus, a destination server of the second message on the basis of the extracted second server identifier, the destination server being one of the plurality of servers; and
transmitting the second message destined to an address of the determined destination server.

2. The relay method according to claim 1, further comprising:
extracting a first application identifier from the response, the first application identifier being for identifying a first application relating to the first message;
storing in the data storage the extracted first application identifier in association with the first session identifier;
extracting a second application identifier from the data storage on the basis of the second session identifier,
wherein
the relay apparatus determines the destination server on the basis of the extracted second application identifier and a third application identifier included in the second message.

3. A non-transitory computer-readable medium storing a program causing a computer to execute a procedure, the computer being connected to a plurality of servers and a client to relay a message transmitted from the client to one of the plurality of servers, the procedure comprising:
receiving from one of the plurality of servers a response to a first message transmitted from the client;
storing in a data storage a first server identifier in association with a first session identifier included in the response, the first server identifier being for identifying the one of the plurality of servers that has transmitted the response;
extracting, upon receiving a second message transmitted from the client, a second server identifier from the data storage on the basis of a second session identifier included in the second message, the second server identifier being for identifying an advance server;
determining a destination server of the second message on the basis of the extracted second server identifier, the destination server being one of the plurality of servers; and
transmitting the second message destined to an address of the determined destination server.

4. The non-transitory computer-readable medium according to claim 3, the procedure further including:
extracting a first application identifier from the response, the first application identifier being for identifying a first application relating to the first message;
storing in the data storage the extracted first application identifier in association with the first session identifier;
extracting a second application identifier from the data storage on the basis of the second session identifier,
wherein
the computer determines the destination server on the basis of the extracted second application identifier and a third application identifier included in the second message.

5. A relay apparatus connected to a plurality of servers and a client to relay a message transmitted from the client to one of the plurality of servers, the relay apparatus comprising:
a receiving means for receiving from one of the plurality of servers a response to a first message transmitted from the client;
a data storage configured to store a first server identifier in association with a first session identifier included in the response, the first server identifier being for identifying the one of the plurality of servers that has transmitted the response; and
a transmitting means for
extracting, upon receiving a second message transmitted from the client, a second server identifier from the data storage on the basis of a second session identifier included in the second message, the second server identifier being for identifying an advance server,
determining a destination server of the second message on the basis of the extracted second server identifier, the destination server being one of the plurality of servers, and transmitting the second message destined to an address of the determined destination server.

6. The relay apparatus according to claim 5, wherein
the data storage stores, in association with the first session identifier, a first application identifier extracted from the response, the first application identifier being for identifying a first application relating to the first message, and
the transmitting means
extracts a second application identifier from the data storage on the basis of the second session identifier, and
determines the destination server on the basis of the extracted second application identifier and a third application identifier included in the second message.

7. A relay apparatus connected to a plurality of servers and a client to relay a message transmitted from the client to one of the plurality of servers, the relay apparatus comprising:
a processor configured to execute a procedure, the procedure comprising:
receiving from one of the plurality of servers a response to a first message transmitted from the client;
storing in a data storage a first server identifier in association with a first session identifier included in the response, the first server identifier being for identifying the one of the plurality of servers that has transmitted the response;
extracting, upon receiving a second message transmitted from the client, a second server identifier from the data storage on the basis of a second session identifier included in the second message, the second server identifier being for identifying an advance server;
determining, by the relay apparatus, a destination server of the second message on the basis of the extracted second server identifier, the destination server being one of the plurality of servers; and
transmitting the second message destined to an address of the determined destination server.
